(19) United States
(12) Patent Application Publication
(10) Pub. No.: US 2006/0117330 A1
(43) Pub. Date: Jun. 1, 2006

(54) Disk player for vehicles

(75) Inventor: Yun Bok Choi, Kyunggi-do (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd.

(21) Appl. No.: 11/101,726

(22) Filed: Apr. 7, 2005

(30) Foreign Application Priority Data
Nov. 30, 2004 (KR) 2004-99150

(51) Int. Cl. G11B 17/04

(52) U.S. Cl. 720/619

(57) ABSTRACT

The present invention discloses a disk player for vehicles being able to be operated with two motors. The player comprises first rotary unit, second rotary unit, third rotary unit being selectively coupled to the first rotary unit, a switchable gear assembly selectively coupling the first rotary unit to the second or third rotary unit, fourth rotary unit being selectively coupled to the third rotary unit, and a rotating lever coupling the third rotary unit to the fourth rotary unit during disk loading and unloading and decoupling the third rotary unit from the fourth rotary unit during a final stage of disk loading.

### BACKGROUND OF THE INVENTION

1. Field of the Invention

The present invention relates generally to disk players for vehicles and, more particularly, to a disk player for vehicles which is capable of executing disk loading and unloading and pickup conveying operations using one drive motor.

2. Description of the Related Art

As well known to those skilled in the art, a disk player for vehicles is a device which is provided in a vehicle for reproducing the information, such as music, recorded on recoding medium that is called a CD (compact disk). Typically, conventional disk players includes three motors, that is, a loading motor for disk loading and unloading, a feeding motor for pickup conveying, and a spindle motor to rotate the disk.

FIG. 17 is an exploded perspective view showing a representative example of conventional disk players for vehicles. As shown in FIG. 17, in a conventional disk player 10, when a disk is inserted into the disk player 10, a loading motor 12, fastened to a lower frame 11 by a locking means such as a locking bolt, is operated. Then, a motor gear 13, provided around an output shaft of the loading motor 12, rotates.

A gear assembly 14, which engages with the motor gear 13, is rotated by the rotation of the motor gear 13. A loading gear 15, which engages with the gear assembly 14, is also rotated. A roller shaft 16, over which the loading gear 15 is fitted, is rotated by the rotation of the loading gear 15. A clutch gear 141 of the gear assembly 14 is coupled to a gear pulley 18 through a belt 17. The gear pulley 18 engages with an idle gear 19. Furthermore, the idle gear 19 is coupled to a gear cam 20 which is coupled to a follow arm 21, thus forming a loading mechanism of the disk player 10. To prevent the gear cam 20 and the follow arm 21 from being worn due to contact between them, a follow bushing 22 is interposed between the gear cam 20 and the follow arm 21.

In a final stage of disk loading, a roller arm 23 touches a switch 25 which is provided on a substrate 24, thus operating a feeding motor 26. The feeding motor 26 is fastened to a main frame 28 through a support bracket 27 by a locking means such as a locking bolt. A motor gear 29 is provided around an output shaft of the feeding motor 26. When the motor gear 29 is rotated by a driving force of the feeding motor 26, the rotating force of the motor gear 29 transmits to a lead screw 32 through an idle gear 30 and a lead screw gear 31. Then, a pickup 33, coupled to the lead screw 32, is moved in a radial direction of the disk by the rotation of the lead screw 32.

When the disk, inserted into the disk player 10, is seated on a turntable 34, the spindle motor 35 is operated. The pickup 33, moved by the feeding motor 26 in the radial direction of the disk, reproduces the information recorded on the disk.

To eject the disk from the disk player 10, the feeding motor 26 is rotated in reverse in response to the eject command from a user. Thus, the pickup 33 moves toward the spindle motor 35. When the pickup 33 is moved to the innermost position, the pickup 33 operates a home position switch 37 which is provided on an auxiliary substrate 36. Just as the home position switch 37 is operated, the loading motor 12 is reversely rotated. Then, the components coupled to the loading motor 12 are reversely rotated. As a result, the disk is ejected from the disk player 10 by the reverse rotation of the roller shaft 16.

However, the conventional disk player 10 requires two motors, that is, both the loading motor and feeding motor for the disk loading and unloading and pickup conveying. Accordingly, the conventional disk player 10 is problematic in that price competitive power of the products is decreased due to the expensive motors and switches to control the motors.

### SUMMARY OF THE INVENTION

Accordingly, the present invention has been made keeping in mind the above problems occurring in the prior art, and an object of the present invention is to provide a disk player for vehicles which can execute disk loading and unloading and pickup conveying operations using only one drive motor and relatively simple components, such as a switchable gear assembly, a switching plate and a rotating lever, etc.

In order to accomplish the above object, the present invention provides a disk player for vehicles, including: a drive motor being driven when a disk is in the disk player and being stopped when no disk is in the disk player; a first rotary unit rotatably coupled to the drive motor; a second rotary unit selectively coupled to the first rotary unit to operate a pickup conveying unit; a third rotary unit selectively coupled to the first rotary unit, thus being rotated during disk loading and disk unloading, but being stopped during pickup conveying; a switchable rotor to selectively couple the first rotary unit to the second or third rotary unit during pickup conveying or disk loading and unloading, respectively, so that the switchable rotor transmits a rotating force from the first rotary unit to the second or third rotary unit; a fourth rotary unit selectively coupled to the third rotary unit so that, when the fourth rotary unit is rotated or reversely rotated, the disk is loaded or unloaded and, when the disk is completely loaded, the fourth rotary unit is stopped; and a rotation switching unit on which the third rotary unit is rotatably mounted, the rotation switching unit coupling the third rotary unit to the fourth rotary unit during disk loading and unloading, and decoupling the third rotary unit from the fourth rotary unit during a final stage of the disk loading.

The switchable rotor may include an upper switchable rotor body and a lower switchable rotor body which are vertically and elastically movable, so that, when the upper and lower switchable rotor bodies move upwards, the upper switchable rotor body is coupled to the second rotary unit, and when the upper and lower switchable rotor bodies move downwards, the lower switchable rotor body is coupled to the third rotary unit.

The switchable rotor may further include a rotating shaft, a lower spring support plate, a lower spring, an upper spring and an upper spring support plate, so that the lower spring support plate, the lower switchable rotor body, the lower spring, the upper switchable rotor body, the upper spring and the upper spring support plate are sequentially provided around the rotating shaft.

The upper spring may have an elastic modulus higher than that of the lower spring.

The disk player may further include a switchable rotor drive unit being coupled to the third rotary unit during final stage of the disk loading or during disk unloading, so that the switchable rotor drive unit is advanced below the switchable rotor or retracted from the switchable rotor by the rotating force transmitted thereto through the third rotary unit, thus moving the switchable rotor upwards or downwards during the final stage of disk loading or during disk unloading, respectively.

The switchable rotor drive unit may include a toothed part unit provided on an upper surface of the switchable rotor drive unit, thus engaging with the third rotary unit.

The disk player may further include a rack unit to be coupled to the third rotary unit during the final stage of the disk loading, so that the rack unit is moved by the rotating force transmitted thereto through the third rotary unit, thus advancing the switchable rotor drive unit below the switchable rotor.

The rack unit may include a trigger rack unit elastically supported on the rack unit, thus being linearly movable, so that, during final stage of the disk loading, the trigger rack unit is coupled to the third rotary unit and advanced in a state of being in contact with the disk, and, simultaneously, the rack unit is coupled to the third rotary unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view of a disk player for vehicles, according to a preferred embodiment of the present invention;

FIG. 2 is an exploded perspective view of the disk player of FIG. 1;

FIG. 3 is a view showing gear couplings in the disk player of FIG. 1;

FIG. 4 is a view showing the coupling of a switchable gear assembly to a second feeding gear of FIG. 3;

FIG. 5 is a view showing the decoupling of the switchable gear assembly from a third feeding gear of FIG. 3;

FIG. 6 is a view showing couplings among a roller gear and fourth, fifth and sixth loading gears of FIG. 2;

FIG. 7 is a view showing some of the gear coupling of the disk player of FIG. 1 in an initial stage of loading a disk;

FIGS. 8a and 8b are views showing the operation of a rotating lever and a rack unit of FIG. 1 during disk loading;

FIG. 9a is a view showing the coupling of a second loading gear to the fifth loading gear of FIG. 3;

FIG. 9b is a view showing the decoupling of the second loading gear from the fifth loading gear of FIG. 9a by the linear movement of the rack unit of FIGS. 8a and 8b;

FIGS. 10a and 10b are views showing linear movement of a switching plate due to the linear movement of the rack unit of FIGS. 9a and 9b;

FIGS. 11a through 11c are views of upward movement of the switchable gear assembly due to the linear movement of the switching plate of FIGS. 10a and 10b;

FIG. 12 is an exploded perspective view of the switchable gear assembly of FIGS. 11a through 11c;

FIGS. 13a and 13b are views showing the coupling of an upper switchable gear of the switchable gear assembly of FIGS. 11a through 11c to the third feeding gear due to the upward movement of the switchable gear assembly;

FIG. 14a is a view showing a pickup held by a rotating lever during the linear movement of the switching plate of FIGS. 10a and 10b;

FIG. 14b is a view showing the pickup released from the rotating lever during the linear movement of the switching plate of FIGS. 10a and 10b;

FIG. 15 is a view showing movement of the pickup by rotation of the third feeding gear coupled to a drive motor of FIG. 3;

FIG. 16 is a view showing retraction of the switching plate from the switchable gear assembly of FIGS. 11a through 11c; and

FIG. 17 is an exploded perspective view showing a conventional disk player for vehicles.

### DESCRIPTION OF THE PREFERRED EMBODIMENTS

Hereinafter, embodiments of the present invention will be described in detail with reference to the attached drawings. Reference now should be made to the drawings, in which the same reference numerals are used throughout the different drawings to designate the same or similar components.

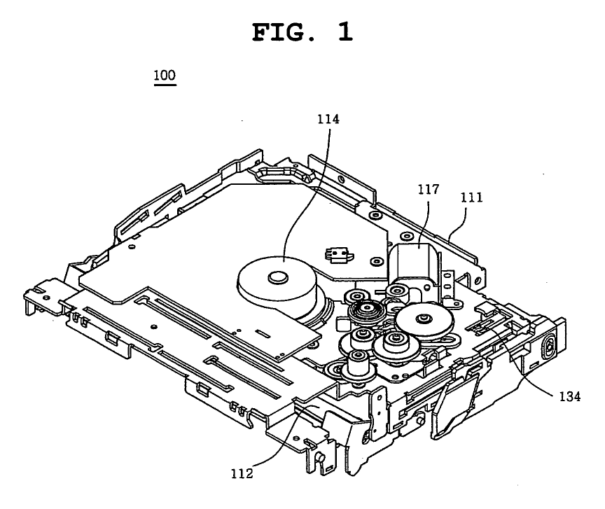

As shown in FIGS. 1 through 3, a disk player 100 for vehicles according to a preferred embodiment of the present invention includes a main frame 111 in which various components are provided.

The disk player 100 further includes a roller shaft 112 provided around an inlet of the main frame 111 through which a disk is inserted into or ejected from the main frame 111. The roller shaft 112 is in close contact with a lower surface the disk and reversibly rotates, thus inserting or ejecting the disk into or from a central portion of the main frame 111. A roller gear 113 is provided around an end of the roller shaft 112.

The disk player 100 further includes a spindle motor 114 which is provided on the central portion of the main frame 111 to rotate the disk. A turntable 115 is provided on an upper surface of the spindle motor 114 so that the turntable 115 is elastically coupled to a coupling hole formed on the center of the disk.

The disk player 100 further includes a drive motor 117 which is provided around the spindle motor 114 to load and unload the disk and generate a drive force for conveying a pickup 116. The drive motor 117 is supported by a motor support 118 which is fastened to the main frame 111 by a locking means such as a locking bolt. A motor gear 119 is provided around an output shaft of the drive motor 117.

The motor gear 119 of the drive motor 117 engages with a first feeding gear 120. A second feeding gear 121 is coupled to the motor gear 119 through the first feeding gear 120. The first and second feeding gears 120 and 121 are a first rotating unit. A third feeding gear 122 selectively engages with the second feeding gear 121 to convey the pickup 116. The third feeding gear 122 engages with a lead screw gear 124 which is provided on an end of a lead screw 123 around the spindle motor 114 to linearly reciprocate the pickup 116 in a radial direction of the disk.

The disk player 100 further includes a switchable gear assembly 125 which is a switchable rotor. An upper switchable gear 1251 of the switchable gear assembly 125 is provided between the second and third feeding gears 121 and 122. The upper switchable gear 1251 selectively couples the third feeding gear 122 to the second feeding gear 121. Here, the second feeding gear 121 is always coupled to the upper switchable gear 1251. The third feeding gear 122 is coupled to the upper switchable gear 1251 during pickup 116 conveying, but the third feeding gear 122 is decoupled from the upper switchable gear 1251 during disk loading and unloading.

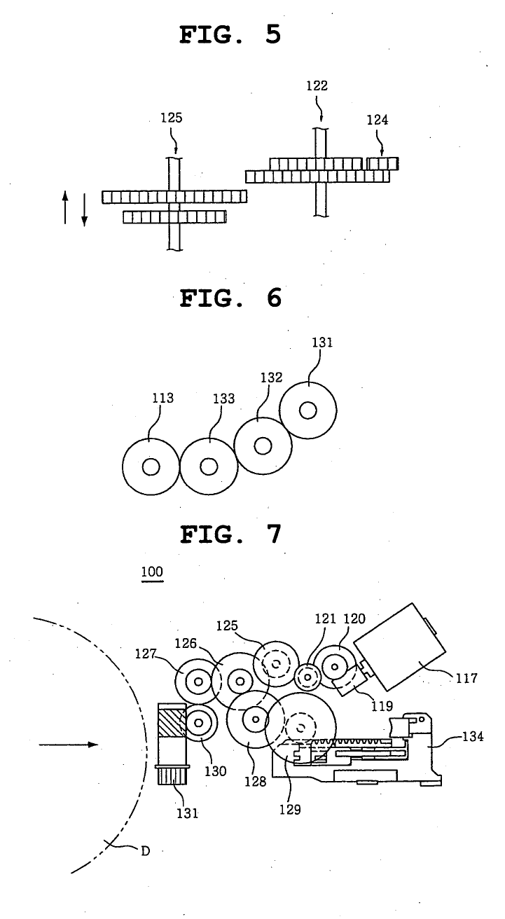

As shown in FIGS. 4 and 5, the height of the second feeding gear 121, which engages with the first feeding gear 120, is about two times that of the upper switchable gear 1251. Therefore, even when the upper switchable gear 1251 is raised to a predetermined height, the upper switchable gear 1251 is not decoupled from the second feeding gear 121. On the other hand, the third feeding gear 122, which engages with the lead screw gear 124, is positioned at a predetermined position higher than that of the switchable gear assembly 125. Thus, the third feeding gear 122 is coupled to the upper switchable gear 1251 when the switchable gear assembly 125 is moved upwards, but they are decoupled from each other when the switchable gear assembly 125 is moved downwards.

In the meantime, the switchable gear assembly 125 is selectively coupled to a first loading gear 126 which is a third rotating unit. That is, a lower switchable gear 1252 of the switchable gear assembly 125 engages with the first loading gear 126 during disk loading and unloading, but it is decoupled from the first loading gear 126 during pickup 116 conveying, because the switchable gear assembly 125 is in the upward position then.

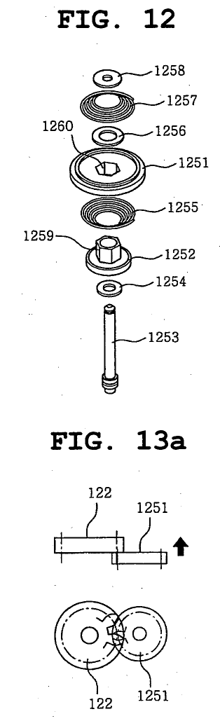

The construction of the switchable gear assembly 125 will be described later herein in detail with reference to FIG. 12.

The first loading gear 126 engages with both a second loading gear 127 and a third loading gear 128. A fourth loading gear 129 is coupled to the first loading gear 126 through the third loading gear 128.

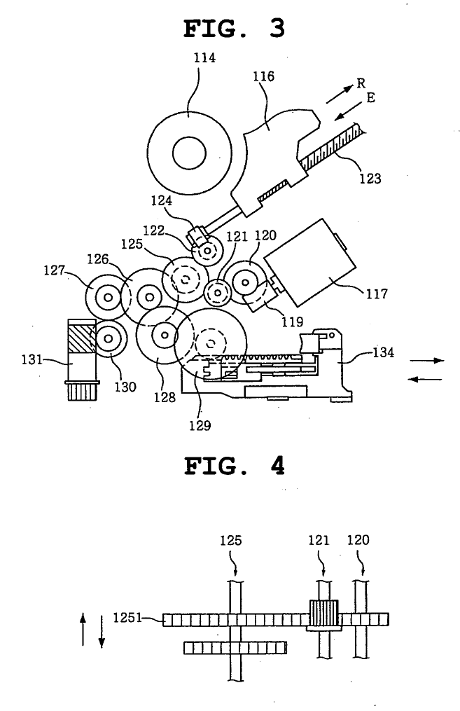

As shown in FIGS. 3 and 6, the second loading gear 127 and fifth, sixth, seventh and eighth loading gears 130, 131, 132 and 133 engage with each other, thus forming a gear train. The fifth, sixth, seventh and eighth loading gears 130, 131, 132 and 133 are defined as a fourth rotating unit. Here, the fifth and sixth loading gears 130 and 131 are provided on a bottom of the main frame 111. The seventh and eighth loading gears 132 and 133 are provided on a sidewall of the mainframe 111.

The eighth loading gear 133 engages with the roller gear 113 which is provided on the end of the roller shaft 112 that inserts or ejects the disk into or from the interior of the main frame 111.

The disk player 100 further includes both a rack unit 134 and a trigger rack unit 135 which are selectively coupled to the fourth loading gear 129. That is, the rack unit 134 and trigger rack unit 135 are coupled to the fourth loading gear 129 during a final stage of disk loading, but they are decoupled from the fourth loading gear 129 during disk unloading. The rack unit 134 and trigger rack unit 135 will be described later herein in detail.

The disk player 100 further includes a first rotating lever 136 which is mounted on the bottom of the main frame 111 through an auxiliary frame 137 to start linear movement of the trigger rack unit 135 during the final stage of disk loading.

The first rotating lever 136 having a tripod shape is provided to be rotatable with respect to the auxiliary frame 137 while being coupled to the main frame 111.

Furthermore, the first rotating lever 136 is coupled to the auxiliary frame 137 by a spring 138. Accordingly, the first rotating lever 136 rotates when an outside force is applied thereto. When the outside force is removed from the first rotating lever 136, the first rotating lever 136 is returned to an original position thereof.

A first protrusion 1361 of the first rotating lever 136 is formed at a position lower than those of second and third protrusions 1362 and 1363, so that the first protrusion 1361 is not in contact with a circumferential edge of the disk while the second protrusion 1362 is in contact with the circumferential edge of the disk. Thus, in the final stage of disk loading, the circumferential edge of the disk comes into contact with the second protrusion 1362 of the first rotating lever 136. At this time, the first rotating lever 136 is rotated by a pushing force of the disk. Then, an assistant link 1364, which is coupled to the third protrusion 1363, pushes the trigger rack unit 135 forwards. This starts the linear movement of the trigger rack unit 135.

The disk player 100 further includes a second rotating lever 139 which is a rotation switching unit and is rotatably coupled to an end of the rack unit 134. The second rotating lever 139 is coupled to the main frame 111 while being rotatable around a rotating shaft of the first loading gear 126. The second loading gear 127 is rotatably mounted on an end of the second rotating lever 139. Therefore, when the rack unit 134 advances forwards, the second rotating lever 139 rotates clockwise. Then, the second loading gear 139 rotates clockwise along the second rotating lever 139. As a result, the second loading gear 127 is decoupled from the fifth loading gear 130.

The disk player 100 further includes a switching plate 140 which is a switchable rotor drive unit and is provided at a predetermined position below a lower surface of the rack unit 134. The switching plate 140 has a plurality of elongate holes thereon. Rotating shafts of the first and second feeding gears 120 and 121, switchable gear assembly 125 and fourth loading gear 129 are inserted into respective elongate holes in the switching plate 140, such that the switching plate 140 is linearly movable below lower surfaces of the first and second feeding gears 120 and 121, switchable gear assembly 125 and fourth loading gear 129. Here, when the rack unit 134 is linearly advanced forwards, the switching plate 140 is linearly advanced forwards and sideways.

The switching plate 140 has a protrusion part 141 which is provided on an upper surface of the switching plate 140 and has an inclined surface that is in close contact with a lower end of the switchable gear assembly 125 while the switching plate 140 is advanced or retracted. A toothed part is formed on a side of the protrusion part 141 of the switching plate 140 to engage with the second feeding gear 121. Therefore, when the switching plate 140 is advanced forwards and sideways by the linear movement of the rack unit 134, the protrusion part 141 engages with the second feeding gear 121, which has rotated, thus allowing the switching plate 140 to be continuously advanced. At this time, the switchable gear assembly 125 moves upwards by the inclined surface of the protrusion part 141, so that the lower switchable gear 1252 is decoupled from the first loading gear 126 while the upper switchable gear 1251 becomes coupled to the third feeding gear 122.

The disk player 100 further includes a third rotating lever 142 which is rotatably mounted on the main frame 111 around the switching plate 140, thus controlling the movement of the pickup 116. In detail, a protrusion 1421 of the third rotating lever 142 selectively stops a stop protrusion 1161 of the pickup 116 while a protrusion 1422 of the third rotating lever 142 is in contact with an edge of the switching plate 140.

Hereinafter, the operation of the disk player 100 of the present invention having the above-mentioned construction will be described in detail.

As shown in FIG. 7, when a disk is inserted into the disk player 100, a sensor (not shown) monitors the insertion of the disk and operates the drive motor 117.

Then, the motor gear 119, which is provided around the output shaft of the drive motor 117, is rotated by the operation of the drive motor 117. Thus, both the first feeding gear 120, which engages with the motor gear 119, and the second feeding gear 121, which engages with the first feeding gear 120, are rotated. Due to the upper switchable gear 1251 engaging with the second feeding gear 121, the switchable gear assembly 125 is rotated and, simultaneously, the first loading gear 126, which engages with the lower switchable gear 1252, is rotated.

As such, when the first loading gear 126 rotates, both the second loading gear 127 and the third loading gear 128 which engage with the first loading gear 126 are rotated. Simultaneously, both the fifth loading gear 130, which engages with the second loading gear 127, and the fourth loading gear 129, which engages with the third loading gear 128, are rotated.

The fifth loading gear 130, which engages with the second loading gear 127, is rotated by the rotation of the second loading gear 127. Simultaneously, the sixth loading gear 131 is rotated by the rotation of the fifth loading gear 130.

The seventh and eighth loading gears (132 and 133 of FIG. 6) which are provided on the sidewall of the main frame 111 are rotated by the rotation of the sixth loading gear 131. Then, the roller gear 113 is rotated by the rotating force transmitted thereto through the eighth loading gear 133.

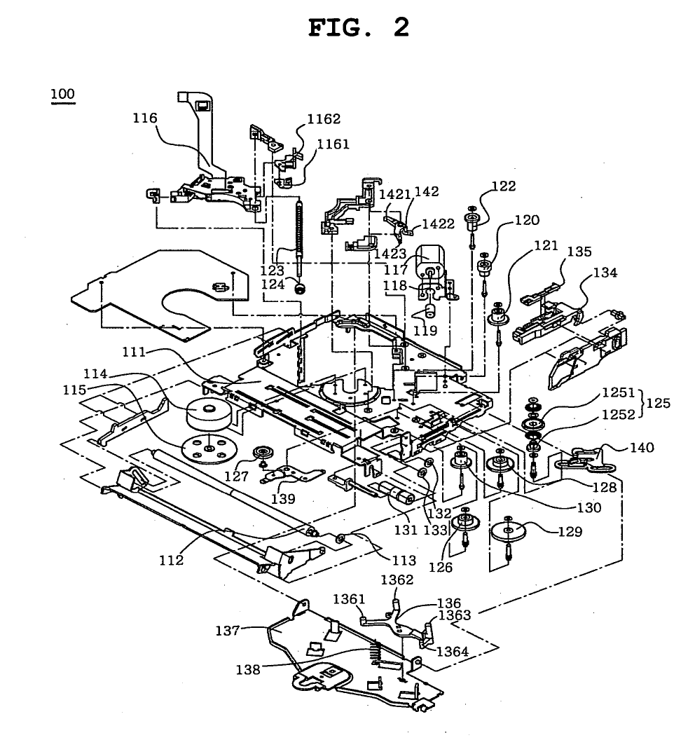

The roller shaft (112 of FIG. 2), around which the roller gear 113 is provided, is rotated by the rotation of the roller gear 113. As a result, a loading process of the disk, which has been in contact with the roller shaft 112, is started by the rotating force of the roller shaft 112.

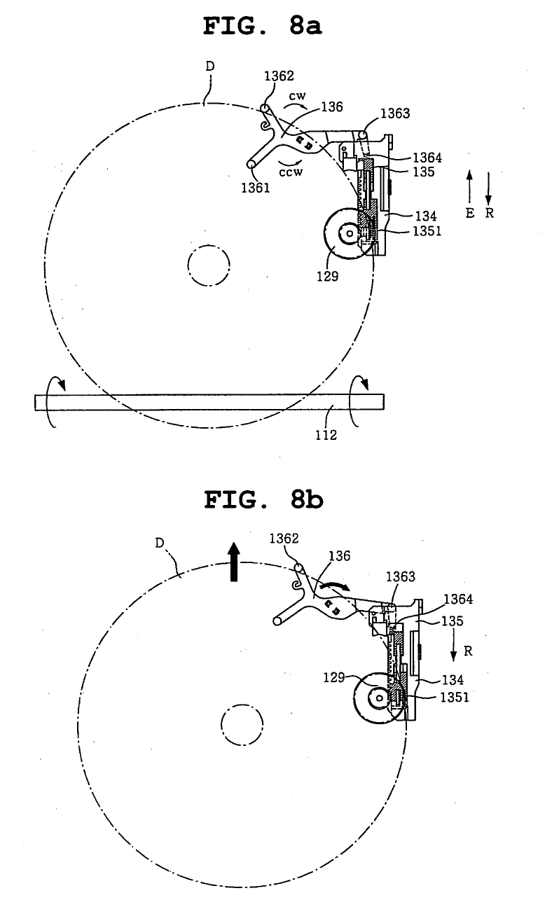

As shown in FIGS. 8a and 8b, in the final stage of the disk loading, a circumferential edge of the disk comes into contact with and pushes the second protrusion 1362 of the first rotating lever 136 rearwards. Therefore, the first rotating lever 136 rotates clockwise (CW), so that the trigger rack unit 135, which is in contact with the assistant link 1364 of the first rotating lever 136, is advanced by a predetermined distance in a direction shown by the arrow R of the FIGS. 8a and 8b.

As the trigger rack unit 135 is advanced forwards, the rack unit 134 and the trigger rack unit 135 becomes coupled to the fourth loading gear 129 which is rotated by the engagement with the third loading gear 128. By the rotating force of the fourth loading gear 129, both the rack unit 134 and the trigger rack unit 135 are further advanced in the direction shown by the arrow R. At this time, a spring 1351, which is interposed between the rack unit 134 and the trigger rack unit 135, is compressed.

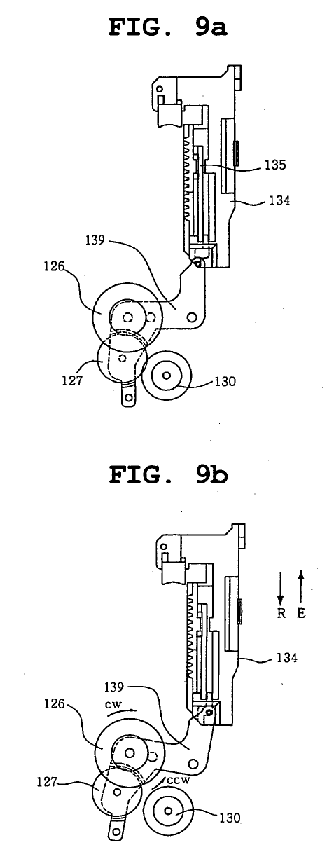

As shown in FIGS. 9a and 9b, when the rack unit 134 and the trigger rack unit 135 are advanced forwards, the second rotating lever 139, which is coupled to the end of the rack unit 134, is rotated clockwise (CW) around the rotating shaft of the first loading gear 126. Then, the second loading gear 127, which is rotatably mounted on the second rotating lever 139, is rotated clockwise (CW) around the rotating shaft of the first loading gear 126 along with the second rotating lever 139. Thus, the second loading gear 127 is decoupled from the fifth loading gear 130.

When the second loading gear 127 and the fifth loading gear 130 are decoupled from each other, the rotation of the fifth loading gear 130 is stopped. As a result of this, the sixth, seventh and eighth loading gears 131, 132 and 133 and the roller gear 113, which have been rotated by the rotation of the fifth loading gear 127, are also stopped. Then, the roller shaft 112 is stopped, so that the disk does not move rearwards any longer.

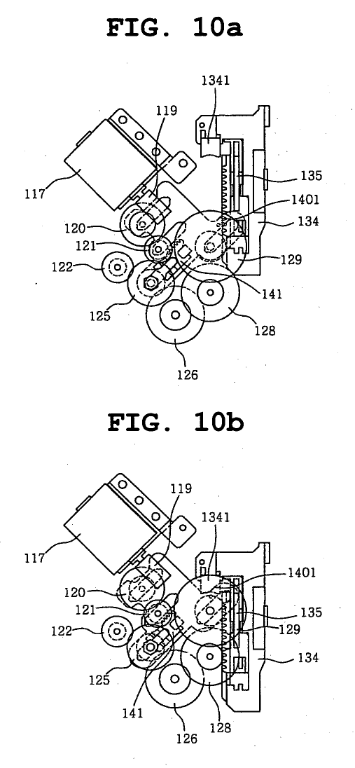

As shown FIGS. 10a and 10b when both the rack unit 134 and the trigger rack unit 135 are advanced forwards, a contact protrusion 1341, provided at a predetermined position on the rack unit 134, pushes the protrusion part 141 of the switching plate 140 in a predetermined direction. By such motive power applied to the switching plate 140, the switching plate 140 is advanced forwards and sideways. Furthermore, when the switching plate 140 is advanced forwards and sideways, the protrusion part 141 having the inclined surface becomes coupled to the second feeding gear 121. Therefore, an additional motive power, generated by the rotation of the second feeding gear 121, is applied to the switching plate 140. As such, the switching plate 140 is advanced forwards and sideways with sufficient motive power.

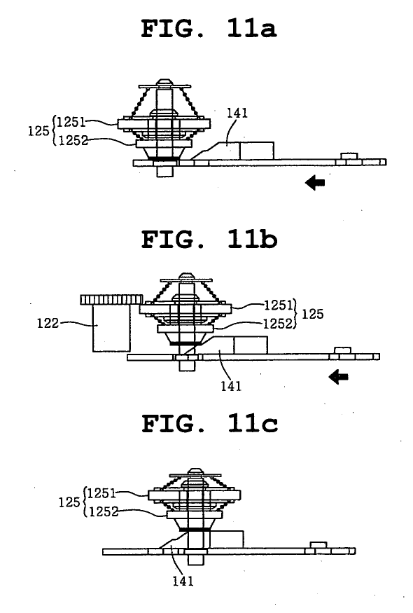

While the switching plate 140 is advanced forwards and sideways, the switchable gear assembly 125 is raised along the inclined surface of the protrusion part 141 of the switching plate 140, as shown in FIGS. 11a through 11c. Then, the lower switchable gear 1252 is decoupled from the first loading gear (126 of FIG. 3), and the upper switchable gear 1251 is coupled to the third feeding gear 122.

As a result, the second, third and fourth loading gears 127, 128 and 129, which are the first rotating unit, as well as the first loading gear 126, are stopped, while the third feeding gear 122 is rotated by the rotating force transmitted thereto through the switchable gear assembly 125.

As shown in FIG. 12, the switchable gear assembly 125 has a rotating shaft 1253 which is fastened to the main frame 111. A lower washer 1254, the lower switchable gear 1252, a lower spring 1255, the upper switchable gear 1251, an intermediate washer 1256, an upper spring 1257 and an upper washer 1258 are sequentially provided around the rotating shaft 1253.

Furthermore, a hollow hexagonal nut 1259 to receive the rotating shaft 1253 therein is provided on an upper surface of the lower switchable gear 1252. The upper switchable gear 1251 has a hexagonal hole 1260 on the center thereof to correspond to the hollow hexagonal nut 1259. As such, the upper switchable gear 1251 is fitted over the hollow hexagonal nut 1259 of the lower switchable gear 1252, so that the upper and lower switchable gears 1251 and 1252 are rotated together.

The upper spring 1257 has an elastic modulus higher than that of the lower spring 1255 to help the movement of the switchable gear assembly 125 described below.

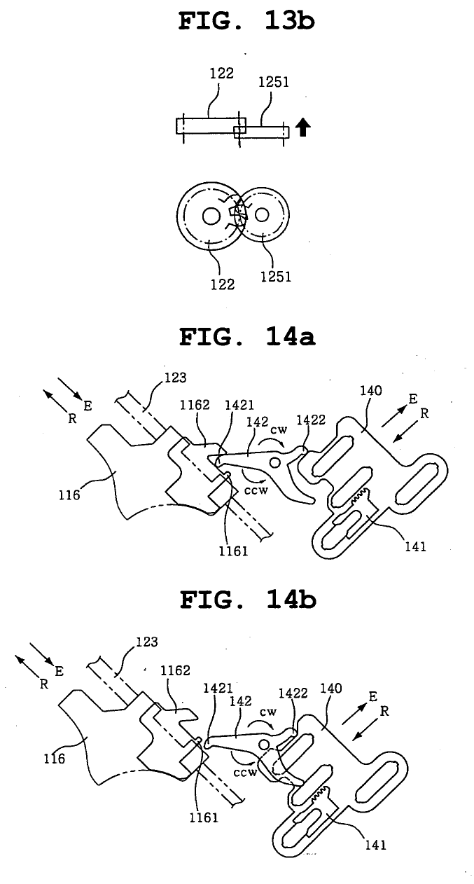

In the switchable gear assembly 125 having the upper and lower springs 1257 and 1255, as shown in FIGS. 13a and 13b, when the upper and lower switchable gears 1251 and 1252, which are rotating, are raised by the switching plate 140, in the case that teeth of the upper switchable gear 1251 incorrectly engage with teeth of the third feeding gear 122 which is in a state of being stopped, the upward movement of the upper switchable gear 1251 is stopped by the third feeding gear 122. At this time, the upper switchable gear 1251 is moved slightly downwards by the shape of a tooth of the third feeding gear 122 and reduces a tolerance space defined by the lower spring 1255 between the upper and lower switchable gears 1251 and 1252. Thus, both the upper switchable gear 1251 and the third feeding gear 122 are prevented from damage due to incorrect engagement between them. Thereafter, when the teeth of the upper switchable gear 1251 are aligned with the teeth of the third feeding gear 122, the upper switchable gear 1251 is moved upwards by restoring force of the lower spring 1255 which has been compressed.

Referring to FIGS. 14a and 14b, when the switching plate 140 is advanced forwards and sideways, the third rotating lever 142 is rotated clockwise (CW) while the protrusion 1422 of the third rotating lever 142 is in contact with the edge of the switching plate 140. The pickup 116, which has been held by the third rotating lever 142 through the stop protrusion 1161 thereof, becomes movable.

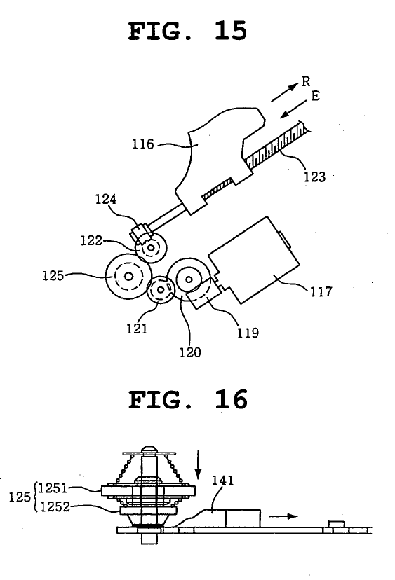

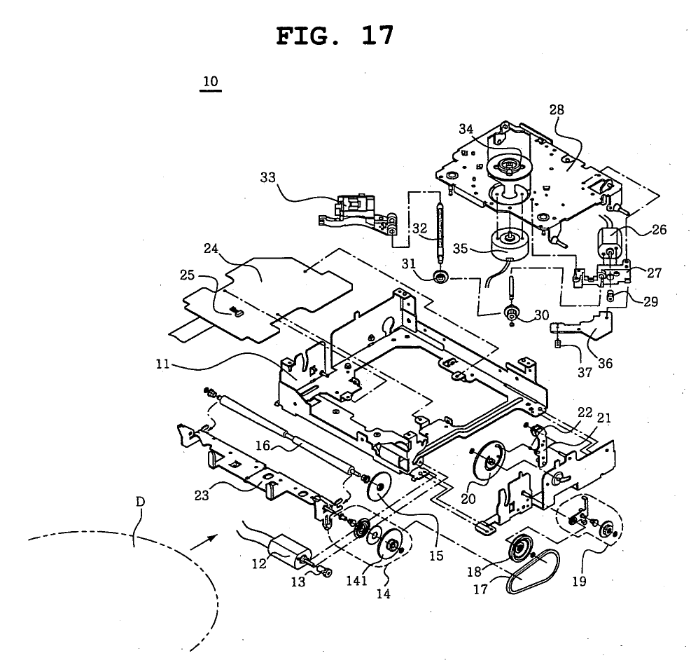

At this time, the lead screw gear 124 is rotated by the third feeding gear 122 which is operated by the engagement with the upper switchable gear 1251 of the switchable gear assembly 125. Simultaneously, the lead screw 123 is rotated along with the lead screw gear 124. Therefore, as shown in FIG. 15, the pickup 116, released from the third rotating lever 142, is moved in a radial direction (in a direction shown by the arrow R of FIG. 15), thus reproducing recorded information from the disk.

Referring to FIG. 15, after such a reproducing process is finished, to eject the disk from the disk player 100, the drive motor 117 is reversely operated by the sensor (not shown) which receives a disk ejection signal. Then, the motor gear 119 is rotated in a reverse direction.

When the motor gear 119 is reversely rotated, the first, second and third feeding gear 120, 121 and 122 are also rotated in a reverse direction. By the reverse rotation of the third feeding gear 122, the lead screw gear 124 is reversely rotated along with the lead screw 123. Thus, the pickup 116 is moved towards the center of the disk, that is, towards the spindle motor 114 (in a direction shown by the arrow E of FIG. 15).

Referring to FIGS. 14a and 14b, when the pickup 116 moves toward the spindle motor 114, a stop protrusion 1162 of the pickup 116 comes into contact with the protrusion 1421 of the third rotating lever 142, thus rotating the third rotating lever 142 counterclockwise (CCW). Then, the protrusion 1422 of the third rotating lever 142 comes into contact with a predetermined portion of the switching plate 140, thus applying a motive power to the switching plate 140.

The switching plate 140, which obtains the motive power by the third rotating lever 142, moves rearwards and sideways (in a direction shown by the arrow E of FIGS. 14a and 14b). At this time, the protrusion part 141, which has the inclined surface and is provided on the upper surface of the switching plate 140, becomes coupled to the second feeding gear 121. By the rotating force of the second feeding gear 121, the switching plate 140 is continuously moved rearwards and sideways.

While the switching plate 140 moves rearwards and sideways until it is returned to the initial position thereof, the switchable gear assembly 125, which has been raised by the switching plate 140, is moved downwards, as shown in FIGS. 3 and 16. Then, the upper switchable gear 1251 is decoupled from the third feeding gear 122, while the lower switchable gear 1252 is coupled to the first loading gear 126.

Referring to FIG. 3, as the first loading gear 126 is rotated in reverse by the engagement with the lower switchable gear 1252, the second loading gear 127 is also rotated in a reverse direction, and the third and fourth loading gears 128 and 129 are sequentially rotated in reverse directions.

Referring to FIGS. 9a, 9b, 10a and 10b, both the rack unit 134 and the trigger rack unit 135 which have been coupled to the fourth loading gear 129 are returned to the original positions thereof by the reverse rotation of the fourth loading gear 129. At this time, the trigger rack unit 135 being decoupled from the fourth loading gear 129 is linearly moved with respect to the rack unit 134 by the restoring force of the spring 1351 interposed between the rack unit 134 and the trigger rack unit 135, thus being returned to the original position thereof.

When the rack unit 134 is returned to the original position thereof, the second rotating lever 139, which is coupled to the end of the rack unit 134, is rotated around the rotating shaft of the first loading gear 126 counterclockwise (CCW). At this time, the second loading gear 127, which is mounted on the second rotating lever 139, is also rotated around the rotating shaft of the first loading gear 126 counterclockwise (CCW). Thus, the second loading gear 127 is coupled to the fifth loading gear 130. The fifth loading gear 130, which obtains a reverse force through the second loading gear 127, sequentially rotates the sixth, seventh and eighth loading gears 131, 132 and 133 and the roller gear 113 in reverse directions. The roller shaft 112, around which the roller gear 113 is provided, is rotated in a reverse direction by the reverse rotation of the roller gear 113.

Referring to FIGS. 8a and 8b, while the trigger rack unit 135 is returned to the original position thereof, the trigger rack unit 135 pushes the assistant link 1364 of the first rotating lever unit 136 rearwards, thus applying a rotating force to the first rotating lever unit 136. Therefore, the first rotating lever unit 136 is rotated counterclockwise (CCW), so that the second protrusion 1362 of the first rotating lever unit 136 pushes the disk toward the roller shaft 112 in a state of being in contact with the circumferential edge of the disk.

Thereafter, the disk, which is moved to the roller shaft 112 by the rotating force of the first rotating lever 136, is ejected outside the disk player 100 by the roller shaft 112 which is reversely rotating.

As described above, the present invention provides a disk player which requires only one drive motor and one switch to execute disk loading and unloading and pickup conveying operations, thus reducing manufacturing costs of the disk player, thereby enhancing price competitive power of the products.

In addition, because both the disk loading and unloading and the pickup conveying are realized by relatively simple components, such as a switchable gear assembly, a switching plate and a rotating lever, etc., the structure of the disk player is simple, and the assembly of the disk player is easy.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A disk player for vehicles, comprising:
a drive motor being driven when a disk is in the disk player and being stopped when no disk is in the disk player;
a first rotary unit rotatably coupled to the drive motor;
a second rotary unit selectively coupled to the first rotary unit to operate a pickup conveying unit;
a third rotary unit selectively coupled to the first rotary unit, thus being rotated during disk loading and disk unloading, but being stopped during pickup conveying;
a switchable rotor to selectively couple the first rotary unit to the second or third rotary unit during the pickup conveying or the disk loading and unloading, respectively, so that the switchable rotor transmits a rotating force from the first rotary unit to the second or third rotary unit;
a fourth rotary unit selectively coupled to the third rotary unit so that, when the fourth rotary unit is rotated or reversely rotated, the disk is loaded or unloaded and, when the disk is completely loaded, the fourth rotary unit is stopped; and
a rotation switching unit on which the third rotary unit is rotatably mounted, the rotation switching unit coupling the third rotary unit to the fourth rotary unit during the disk loading and unloading, and decoupling the third rotary unit from the fourth rotary unit during a final stage of the disk loading.

2. The disk player as set forth in claim 1, wherein the switchable rotor comprises: an upper switchable rotor body and a lower switchable rotor body which are vertically and elastically movable, so that, when the upper and lower switchable rotor bodies move upwards, the upper switchable rotor body is coupled to the second rotary unit, and when the upper and lower switchable rotor bodies move downwards, the lower switchable rotor body is coupled to the third rotary unit.

3. The disk player as set forth in claim 2, wherein the switchable rotor further comprises: a rotating shaft, a lower spring support plate, a lower spring, an upper spring and an upper spring support plate, so that the lower spring support plate, the lower switchable rotor body, the lower spring, the upper switchable rotor body, the upper spring and the upper spring support plate are sequentially provided around the rotating shaft.

4. The disk player as set forth in claim 3, wherein the upper spring has an elastic modulus higher than that of the lower spring.

5. The disk player as set forth in claim 2, further comprising:
a switchable rotor drive unit being coupled to the third rotary unit during the final stage of the disk loading or during the disk unloading, so that the switchable rotor drive unit is advanced below the switchable rotor or retracted from the switchable rotor by the rotating force transmitted thereto through the third rotary unit, thus moving the switchable rotor upwards or downwards during the final stage of disk loading or during the disk unloading, respectively.

6. The disk player as set forth in claim 5, wherein the switchable rotor drive unit comprises:
a toothed part unit provided on an upper surface of the switchable rotor drive unit, thus engaging with the third rotary unit.

7. The disk player as set forth in claim 5, further comprising:
a rack unit to be coupled to the third rotary unit during the final stage of the disk loading, so that the rack unit is moved by the rotating force transmitted thereto through the third rotary unit, thus advancing the switchable rotor drive unit below the switchable rotor.

8. The disk player as set forth in claim 7, wherein the rack unit comprises: a trigger rack unit elastically supported on the rack unit, thus being linearly movable, so that, during the final stage of the disk loading, the trigger rack unit is coupled to the third rotary unit and advanced in a state of being in contact with the disk, and, simultaneously, the rack unit is coupled to the third rotary unit.
